(19) United States
(12) Patent Application Publication
(10) Pub. No.: US 2004/0144963 A1
(43) Pub. Date: Jul. 29, 2004

(54) Conductive thermoplastics with carbon black and carbon nanofibrils

(76) Inventors: Thomas Braig, Dusseldorf (DE); Detlev Joachimi, Krefeld (DE); Marc Vathauer, Koln (DE); Kurt Jeschke, Dusseldorf (DE)

Correspondence Address: BAYER POLYMERS LLC, 100 BAYER ROAD, PITTSBURGH, PA, 15205, US

(21) Appl. No.: 10/737,321

(22) Filed: Dec. 16, 2003

(30) Foreign Application Priority Data
Dec. 19, 2002 (DE) 10259498.8

(51) Int. Cl. B29C 45/00; B29C 47/00; H01C 1/00

(52) U.S. Cl. 252/500; 264/211; 264/328.18

(57) ABSTRACT

The present invention provides thermoplastic molding compositions that are electrically conductive, and which include a combination of carbon nanofibrils and particulate carbon compounds. The compositions of the present invention provide a combination of desirable properties, such as good melt flow, and compositions prepared there from have both low surface resistance and smooth surfaces. In particular, the present invention provides a thermoplastic composition that includes: (A) 99.6 to 10 parts by weight of at least one thermoplastic polymer; (B) 0 to 50 parts by weight of at least one rubber-elastic polymer; (C) 0.2 to 10.0 parts by weight of carbon nanofibrils; (D) 0.2 to 10.0 parts by weight of at least one particulate carbon compound; and (E) 0 to 50 parts by weight of at least one of filler and reinforcing substance.

### CROSS REFERENCE TO RELATED PATENT APPLICATION

The present patent application claims the right of priority under 35 U.S.C. §119 (a)-(d) of German Patent Application No. 102 59 498.8, filed Dec. 19, 2002.

### FIELD OF THE INVENTION

The invention relates to thermoplastics comprising carbon nanofibrils and particulate carbon compounds.

### BACKGROUND OF THE INVENTION

Electrically conductive plastics are required for a large number of applications. The following applications are of primary importance.

Prevention of static charging, e.g. in packagings, in metering systems for aerosols, powders or liquids and, e.g. in electronic components, such as chip carriers, where electrostatic charging must be dissipated or prevented for safety reasons. Electromagnetic shielding of electrical equipment and electronic assemblies, e.g. in the motor vehicle, electronic data processing, information and communications industry. Utilization of the electrochemical reversibility of self-conducting plastics e.g. for polymer batteries or electrodes. Utilization of electrical conductivity, e.g. control of potential in cables, current-dependent switching elements, heating elements or for electrostatic lacquering of components of plastic.

In recent years electrostatic lacquering has become accepted in many sectors, in particular in the motor vehicle industry. A basic prerequisite for electrostatic lacquering is the possibility of being able to apply electrical charges to the moldings to be lacquered. This is easily achieved with metals, but is usually not possible to a sufficient degree with conventional thermoplastics because of their low electrical conductivity.

In many of these applications mentioned, such as, in particular, e.g. for prevention of static charging, electrostatic lacquering or electromagnetic shielding, the surface conductivity required can be established by application of a conductive layer, such as e.g. by metallization, vapour deposition of metal or lacquering or priming with a conductive lacquer or primer. However, application of the conductive surface is labour- and cost-intensive, presents additional sources of error and cannot be used for all geometries without problems, so that there is a great need for conductive plastics which can be employed as an alternative to these surface finishings.

In electrostatic lacquering in the motor vehicle industry, for example, the necessary conductivity is typically established by using so-called primers with conductivity additives, which are applied to the moldings of plastic before the electrostatic lacquering. The conductive layer thereby formed at the same time promotes adhesion of the plastic to the lacquer. Here also, simplification and shortening of the process, reduction in sources of error and saving of costs by saving the electrostatic primer are the main reasons for the demand for electrically conductive plastics.

To prepare conductive thermoplastics, conductive substances, such as e.g. carbon black, carbon fibers, graphite, metal fibers and powders, metallized glass fibers or conductive polymers with a conjugated electron system, such as, for example, polyaniline, poly-para-phenylenevinylene or polythiophene, are conventionally employed.

In addition to conductivity, high demands are also made on thermoplastics in uses in the motor vehicle sector in particular, such as in respect of first class surface quality, high toughness, low density, high flowability and low price. Carbon in various modifications, such as, carbon black, carbon fibers, graphite or nanographite, is often employed as a conductivity additive for thermoplastics.

Because of the high concentration required, the use of carbon black and carbon fibers often leads to a deterioration in the surface quality, the toughness (e.g. due to accelerated crystallization in partly crystalline thermoplastics) and the flowability (e.g. due to thixotropy) because comparatively high carbon black concentrations are necessary for the conductivities required (R. G. Gilg, “Ruβ für leitfähige Kunststoffe” in: Elektrisch leitende Kunststoffe, ed.: H. J. Mair, S. Roth, 2nd ed., Carl Hanser Verlag, 1989, Munich, Vienna, p. 21-36).

By the use of carbon nanofibrils, such as are available from Hyperion Catalysis, only comparatively small amounts must be added in order to achieve adequate conductivities (U.S. Pat. No. 5,643,502,WO-A 01/36536). Nevertheless, homogeneous dispersion of the carbon nanofibrils in the polymer matrix is very difficult, since nanographite tends to form aggregates. This severely limits the use of nanographite and carbon nanofibrils and essentially requires the use of masterbatches. In addition, the availability of nanographite or carbon nanofibrils is severely limited due to the involved and very expensive preparation process.

The addition of various modifications of carbon as additives to thermoplastics to establish conductivity is known in the literature, e.g. particulate carbon compounds, such as carbon blacks or graphite powder or fibrous carbon modifications. Thus, the preparation and the properties of conductivity carbon blacks and the carbon black concentrations required for the desired conductivity have been known for a long time (R. G. Gilg, “Ruβ für leitfähige Kunststoffe” in: Elektrisch leitende Kunststoffe, ed.: H. J. Mair, S. Roth, 2nd ed., Carl Hanser Verlag, 1989, Munich, Vienna, p. 21-36). The use of carbon black in thermoplastics to establish conductivity for thermoplastic moldings which can be lacquered electrostatically for uses in the motor vehicle sector is furthermore described in U.S. Pat. No. 5,484,838.

In addition to particulate carbon compounds, carbon fibers, including carbon nanofibrils, can also be added as conductivity additives. U.S. Pat. No. 5,643,502 describes the preparation of carbon nanofibrils and incorporation thereof into thermoplastics, such as polyamide, polycarbonate or polyester, to give masterbatches or molding compositions. In the preferred range, between 2 and 5 wt. % of the nanographite or carbon nanofibrils are used for the preparation of conductive thermoplastic molding compositions, which are distinguished by a very good impact strength in spite of conductivity. WO-A 01/36536 describes the use of carbon nanofibrils in polyamide-polyphenylene ether blends for the preparation of conductive thermoplastic molding compositions.

### SUMMARY OF THE INVENTION

The object was therefore to prepare conductive thermoplastics which have a first class surface quality, high toughness, low density and high flowability. In particular, molding compositions which are suitable for uses for electrostatic lacquering in the motor vehicle interior and exterior sector and/or for uses for prevention of static charging were to be developed.

It has now been found, surprisingly, that with the simultaneous use of carbon nanofibrils and particulate carbon compounds a profile of properties is obtained in which good flowability and low surface resistance are combined. Conductive molding compositions which moreover are distinguished by a very good surface quality and high toughness are obtained by this means.

The molding compositions according to the invention are outstandingly suitable, for example, for electrostatic lacquering or for use in applications where electrostatic charging should be prevented.

In accordance with the present invention, there is provided, a thermoplastic composition comprising:

A) 99.6 to 10, preferably 99.5 to 40, more preferably 99.0 to 55 parts by wt. of at least one thermoplastic polymer;

B) 0 to 50, preferably 0 to 35, more preferably 2 to 35, particularly preferably 5 to 25 parts by wt. of at least one rubber-elastic polymer;

C) 0.2 to 10.0, preferably 0.5 to 5.0, particularly preferably 1.0 to 3.0, most preferably 1.5 to 2.5 parts by wt. of carbon fibers or carbon nanofibrils;

D) 0.2 to 10.0, preferably 0.5 to 8.0, particularly preferably 1.0 to 5.0, most preferably 1.5 to 4.0 parts by wt. of at least one particulate carbon compound, preferably carbon black or graphite powder, which is suitable as an electrically conductivity additive; and

E) 0 to 50, preferably 2 to 40, particularly preferably 5 to 30 parts by wt. of at least one filler and/or reinforcing substance.

Unless otherwise indicated, all numbers or expressions, such as those expressing structural dimensions, quantities of ingredients, etc. used in the specification and claims are understood as modified in all instances by the term “about.”

### DETAILED DESCRIPTION OF THE INVENTION

As component A the compositions preferably comprise, according to the invention, a thermoplastic, such as, for example, polyolefins, e.g. polyethylene and polypropylene, polystyrene, polyvinyl chloride and/or polyoxymethylene polymers, polyimides, polyether-ketones, polyethers, polyacrylate, polymethacrylate, polymethyl methacrylate, polycarbonate, polyamides, polyesters or thermoplastic polyurethanes. The compositions preferably comprise as component A at least one thermoplastic from the group consisting of polycarbonates, polyamides, such as, for example, polyamide 6 or polyamide 6,6, and polyesters, such as, for example, polyalkylene terephthalates, e.g. polybutylene terephthalate or polyethylene terephthalate. A mixture of two or more thermoplastics can also preferably be employed according to the invention as component A. Mixtures which comprise polycarbonate and polyester, such as, for example, polycarbonate/polybutylene terephthalate blends or polycarbonate/polyethylene terephthalate blends, are particularly preferred.

Polyamides are preferably employed as component A. The polyamides according to the invention can be prepared by various processes and synthesized from very different units, and in the specific case of use can be treated, by themselves or in combination, with processing auxiliaries, stabilizers, polymeric blending partners (e.g. elastomers) or also reinforcing materials (such as e.g. mineral fillers or glass fibers) to give materials with specifically established combinations of properties. Blends with contents of other polymers, e.g. of polyethylene, polypropylene or ABS, are also suitable, it being possible optionally to employ one or more compatibilizing agents. The properties of the polyamides can be improved by addition of elastomers, e.g. in respect of the impact strength of e.g. reinforced polyamides. The large number of possible combinations allows a very large number of products with the most diverse properties.

A large number of procedures have been disclosed for the preparation of polyamides, various monomer units, various chain regulators for establishing a required molecular weight or also monomers with reactive groups for after-treatments intended later being employed, depending on the desired end product.

The industrially relevant processes for the preparation of polyamides usually proceed via polycondensation in the melt. Hydrolytic polymerization of lactams is also understood as polycondensation in this context.

Preferred polyamides are partly crystalline polyamides, which can be prepared starting from diamines and dicarboxylic acids and/or lactams having at least 5 ring members or corresponding amino acids.

Possible starting products are aliphatic and/or aromatic dicarboxylic acids, such as adipic acid, 2,2,4- and 2,4,4-trimethyladipic acid, azelaic acid, sebacic acid, isophthalic acid, terephthalic acid, aliphatic and/or aromatic diamines, such as e.g. tetramethylenediamine, hexamethylenediamine, 1,9-nonanediamine, 2,2,4- and 2,4,4-trimethylhexamethylenediamine, the isomeric diaminodicyclohexylmethanes, diaminodicyclohexylpropanes, bis-aminomethylcyclohexane, phenylenediamines and xylylenediamines, aminocarboxylic acids, such as e.g. aminocaproic acid, and the corresponding lactams. Copolyamides of several of the monomers mentioned are included.

Caprolactams are particularly preferably employed, very particularly preferably ε-caprolactam.

The compounds which are usually based on PA6, PA66 and other aliphatic and/or aromatic polyamides or copolyamides and in which 3 to 11 methylene groups occur per one polyamide group in the polymer chain are furthermore particularly suitable.

The polyamides prepared according to the invention can also be employed in a mixture with other polyamides and/or further polymers.

Conventional additives, such as e.g. mold release agents, stabilizers and/or flow agents, can be admixed to the polyamides in the melt or applied to the surface.

Partly aromatic polyesters can also preferably be employed as component A. The partly aromatic polyesters according to the invention are chosen from the group consisting of derivatives of polyalkylene terephthalates, and are preferably chosen from the group consisting of polyethylene terephthalates, polytrimethylene terephthalates and polybutylene terephthalates, particularly preferably polybutylene terephthalate, very particularly preferably polybutylene terephthalate.

Partly aromatic polyesters are understood as meaning materials which also contain aliphatic molecular parts, in addition to aromatic molecular parts.

Polyalkylene terephthalates in the context of the invention are reaction products of aromatic dicarboxylic acids or their reactive derivatives (e.g. dimethyl esters or an hydrides) and aliphatic, cycloaliphatic or araliphatic diols and mixtures of these reaction products.

Preferred polyalkylene terephthalates can be prepared from terephthalic acid (or its reactive derivatives) and aliphatic or cycloaliphatic diols having 2 to 10 C atoms by known methods (Kunststoff-Handbuch, vol. VIII, p. 695 et seq., Karl-Hanser-Verlag, Munich 1973).

Preferred polyalkylene terephthalates comprise at least 80, preferably 90 mol %, based on the dicarboxylic acid, of terephthalic acid radicals and at least 80, preferably at least 90 mol %, based on the diol component, of radicals of ethylene glycol and/or propane-1,3-diol and/or butane-1,4-diol.

The preferred polyalkylene terephthalates can comprise, in addition to terephthalic acid radicals, up to 20 mol % of radicals of other aromatic dicarboxylic acids having 8 to 14 C atoms or aliphatic dicarboxylic acids having 4 to 12 C atoms, such as radicals of phthalic acid, isophthalic acid, naphthalene-2,6-dicarboxylic acid, 4,4′-diphenyldicarboxylic acid, succinic, adipic or sebacic acid, azelaic acid, cyclohexanediacetic acid and cyclohexanedicarboxylic acid.

The preferred polyalkylene terephthalates can comprise, in addition to radicals of ethylene glycol or propane-1,3-diol or butane-1,4-diol, up to 20 mol % of other aliphatic diols having 3 to 12 C atoms or cycloaliphatic diols having 6 to 21 C atoms, e.g. radicals of propane-1,3-diol, 2-ethylpropane-1,3-diol, neopentylglycol, pentane-1,5-diol, hexane-1,6-diol, cyclohexane-1,4-dimethanol, 3-methylpentane-2,4-diol, 2-methylpentane-2,4-diol, 2,2,4-trimethylpentane-1,3-diol and -1,5-diol, 2-ethylhexane-1,3-diol, 2,2-diethylpropane-1,3-diol, hexane-2,5-diol, 1,4-di-(β-hydroxyethoxy)-benzene, 2,2-bis-(4-hydroxycyclohexyl)-propane, 2,4-dihydroxy-1,1,3,3-tetramethylcyclobutane, 2,2-bis-(3-β-hydroxyethoxyphenyl)-propane and 2,2-bis-(4-hydroxypropoxyphenyl)-propane (DE-A 24 07 674, 24 07 776, 27 15 932).

The polyalkylene terephthalates can be branched by incorporation of relatively small amounts of 3- or 4-hydric alcohols or 3- or 4-basic carboxylic acids, such as are described e.g. in DE-A 19 00 270 and U.S. Pat. No. 3,692,744. Examples of preferred branching agents are trimesic acid, trimellitic acid, trimethylolethane and -propane and pentaerythritol.

It is advisable to use not more than 1 mol % of the branching agent, based on the acid component.

Polyalkylene terephthalates which have been prepared solely from terephthalic acid and reactive derivatives thereof (e.g. dialkyl esters thereof) and ethylene glycol and/or propane-1,3-diol and/or butane-1,4-diol (polyethylene terephthalate and polybutylene terephthalate) and mixtures of these polyalkylene terephthalates are particularly preferred.

Copolyesters which are prepared from at least two of the abovementioned acid components and/or from at least two of the abovementioned alcohol components are also preferred polyalkylene terephthalates, particularly preferred copolyesters being poly(ethylene glycol/butane-1,4-diol) terephthalates.

The polyalkylene terephthalates in general have an intrinsic viscosity of approx. 0.4 to 1.5, preferably 0.5 to 1.3, in each case measured in phenol/o-dichlorobenzene (1:1 parts by wt.) at 25° C.

The polyesters prepared according to the invention can also be employed in a mixture with other polyesters and/or further polymers.

Conventional additives, such as e.g. mold release agents, stabilizers and/or flow agents, can be admixed to the polyesters in the melt or applied to the surface.

Polycarbonates or a mixture of polycarbonates can also preferably be employed according to the invention as component A.

Preferred polycarbonates are those homopolycarbonates and copolycarbonates based on the bisphenols of the general formula (I)

HO—Z—OH (I)

wherein

Z is a divalent organic radical having 6 to 30 C atoms which contains one or more aromatic groups.

Preferred bisphenols are those of the formula (Ia)

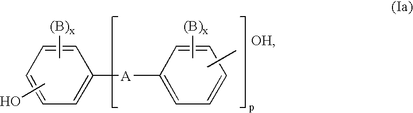

wherein

A is a single bond, C₁-C₅-alkylene, C₂-C₅-alkylidene, C₅-C₆-cycloalkylidene, —O—, —SO—, —CO—, —S—, —SO₂—, C₆-C₁₂-arylene, on to which further aromatic rings optionally containing heteroatoms can be fused,

or a radical of the formula (II) or (III)

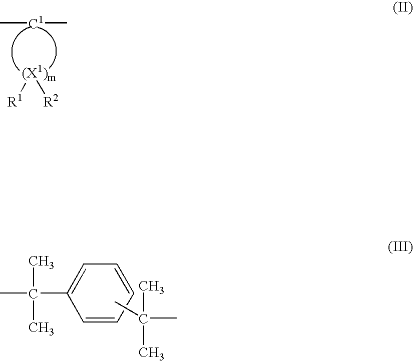

B is in each case C₁-C₁₂-alkyl, preferably methyl, or halogen, preferably chlorine and/or bromine,

x in each case independently of one another is 0, 1 or 2,

p is 1 or 0 and

R¹ and R² can be chosen individually for each X¹ and independently of one another denote hydrogen or C₁-C₆-alkyl, preferably hydrogen, methyl or ethyl,

X¹ denotes carbon and

m denotes an integer from 4 to 7, preferably 4 or 5, with the proviso that on at least one atom X¹, R¹ and R² are simultaneously alkyl.

Examples of bisphenols according to the general formula (I) are bisphenols which belong to the following groups: dihydroxydiphenyls, bis-(hydroxyphenyl)-alkanes, bis-(hydroxyphenyl)-cycloalkanes, indanebisphenols, bis-(hydroxyphenyl) sulfides, bis-(hydroxyphenyl) ethers, bis-(hydroxyphenyl) ketones, bis-(hydroxyphenyl) sulfones, bis-(hydroxyphenyl)-sulfoxides and α,α′-bis-(hydroxyphenyl)-diisopropyl-benzenes.

Derivatives of the bisphenols mentioned which are accessible, for example, by alkylation or halogenation on the aromatic rings of the bisphenols mentioned are also examples of bisphenols according to the general formula (I).

Examples of bisphenols according to the general formula (I) are, in particular, the following compounds: hydroquinone, resorcinol, 4,4′-dihydroxydiphenyl, bis-(4-hydroxyphenyl) sulfide, bis-(4-hydroxyphenyl) sulfone, bis-(3,5-dimethyl-4-hydroxyphenyl)-methane, bis-(3,5-dimethyl-4-hydroxyphenyl) sulfone, 1,1-bis-(3,5-dimethyl-4-hydroxyphenyl)-p/m-diisopropylbenzene, 1,1-bis-(4-hydroxyphenyl)-1-phenyl-ethane, 1,1-bis-(3,5-dimethyl-4-hydroxyphenyl)-cyclohexane, 1,1-bis-(4-hydroxyphenyl)-3-methylcyclohexane, 1,1-bis-(4-hydroxyphenyl)-3,3-dimethylcyclohexane, 1,1-bis-(4-hydroxyphenyl)-4-methylcyclohexane, 1,1-bis-(4-hydroxyphenyl)-cyclohexane, 1,1-bis-(4-hydroxyphenyl)-3,3,5-trimethyl-cyclohexane, 2,2-bis-(3,5-dichloro-4-hydroxyphenyl)-propane, 2,2-bis-(3-methyl-4-hydroxyphenyl)-propane, 2,2-bis-(3,5-dimethyl-4-hydroxyphenyl)-propane, 2,2-bis-(4-hydroxyphenyl)-propane, (i.e. bisphenol A), 2,2-bis-(3-chloro-4-hydroxyphenyl)-propane, 2,2-bis-(3,5-dibromo-4-hydroxyphenyl)-propane, 2,4-bis-(4-hydroxyphenyl)-2-methylbutane, 2,4-bis-(3,5-dimethyl-4-hydroxyphenyl)-2-methylbutane, α,α′-bis-(4-hydroxyphenyl)-o-diiso-propylbenzene, α,α′-bis-(4-hydroxyphenyl)-m-diisopropylbenzene (i.e. bisphenol M), α, α′-bis-(4-hydroxyphenyl)-p-diisopropylbenzene and indanebisphenol.

Particularly preferred polycarbonates are the homopolycarbonate based on bisphenol A, the homopolycarbonate based on 1,1-bis-(4-hydroxyphenyl)-3,3,5-trimethylcyclohexane and the copolycarbonates based on the two monomers bisphenol A and 1,1-bis-(4-hydroxyphenyl)-3,3,5-trimethylcyclohexane.

The bisphenols described, according to the general formula (I), can be prepared by known processes, e.g. from the corresponding phenols and ketones.

The bisphenols mentioned and processes for their preparation are described, for example, in the monograph of H. Schnell, “Chemistry and Physics of Polycarbonates”, Polymer Reviews, volume 9, p. 77-98, Interscience Publishers, New York, London, Sidney, 1964 and in U.S. Pat. No. 3,028,635

1,1,-Bis-(4-hydroxyphenyl)-3,3,5-trimethylcyclohexane and its preparation are described e.g. in U.S. Pat. No. 4,982,014.

Indanebisphenols and their preparation are described, for example, in U.S. Pat. No. 3,288,864, in JP-A 60 035 150 and in U.S. Pat. No. 4 334 106. Indanebisphenols can be prepared, for example, from isopropenylphenol or derivatives thereof or from dimers of isopropenylphenol or derivatives thereof in the presence of a Friedel-Craft catalyst in organic solvents.

Polycarbonates can be prepared by known processes. Suitable processes for the preparation of polycarbonates are, for example, the preparation from bisphenols with phosgene by the phase interface process or from bisphenols with phosgene by the process in a homogeneous phase, the so-called pyridine process, or from bisphenols with carbonic acid esters by the melt transesterification process. These preparation processes are described e.g. in H. Schnell, “Chemistry and Physics of Polycarbonates”, Polymer Reviews, volume 9, p. 31-76, Interscience Publishers, New York, London, Sidney, 1964. The preparation processes mentioned are also described in D. Freitag, U. Grigo, P. R. Muller, H. Nouvertne, “Polycarbonates” in Encyclopedia of Polymer Science and Engineering, volume 11, second edition, 1988, pages 648 to 718 and in U. Grigo, K. Kircher and P. R. Müller “Polycarbonate” in Becker, Braun, Kunststoff-Handbuch, volume 3/1, Polycarbonate, Polyacetale, Polyester, Celluloseester, Carl Hanser Verlag Munich, Vienna 1992, pages 117 to 299 and in D. C. Prevorsek, B. T. Debona and Y. Kesten, Corporate Research Center, Allied Chemical Corporation, Morristown, N.J. 07960, “Synthesis of Poly(estercarbonate) Copolymers” in Journal of Polymer Science, Polymer Chemistry Edition, vol. 19, 75-90 (1980).

The melt transesterification process is described, in particular, in H. Schnell, “Chemistry and Physics of Polycarbonates”, Polymer Reviews, volume 9, p. 44 to 51, Interscience Publishers, New York, London, Sidney, 1964 and in DE-A 1 031 512, in U.S. Pat. No. 3,022,272, in U.S. Pat. No. 5,340,905 and in U.S. Pat. No. 5,399,659.

Raw materials and auxiliary substances with a low degree of impurities are preferably employed in the preparation of polycarbonate. In the preparation by the melt transesterification process in particular, the bisphenols employed and the carbonic acid derivatives employed should be as free as possible from alkali metal ions and alkaline earth metal ions. Raw materials which are pure in this manner are obtainable, for example, by recrystallizing, washing or distilling the carbonic acid derivatives, for example carbonic acid esters, and the bisphenols.

The polycarbonates which are suitable according to the invention preferably have a weight-average molar weight (\overline{M}w), which can be determined e.g. by ultracentrifugation or scattered light measurement, of 10,000 to 200,000 g/mol. They particularly preferably have a weight-average molar weight of 12,000 to 80,000 g/mol, especially preferably 20,000 to 35,000 g/mol.

The average molar weight of the polycarbonates according to the invention can be established, for example, in a known manner by an appropriate amount of chain terminators. The chain terminators can be employed individually or as a mixture of various chain terminators.

Suitable chain terminators are both monophenols and monocarboxylic acids. Suitable monophenols are e.g. phenol, p-chlorophenol, p-tert-butylphenol, cumylphenol or 2,4,6-tribromophenol, and long-chain alkylphenols, such as e.g. 4-(1,1,3,3-tetramethylbutyl)-phenol or monoalkylphenols or dialkylphenols having a total of 8 to 20 C atoms in the alkyl substituents, such as e.g. 3,5-di-tert-butylphenol, p-tert-octylphenol, p-dodecylphenol, 2-(3,5-dimethyl-heptyl)-phenol or 4-(3,5-dimethyl-heptyl)-phenol. Suitable monocarboxylic acids are benzoic acid, alkylbenzoic acids and halogenobenzoic acids.

Preferred chain terminators are phenol, p-tert-butylphenol, 4-(1,1,3,3-tetramethylbutyl)-phenol and cumylphenol.

The amount of chain terminators is preferably between 0.25 and 10 mol %, based on the sum of the particular bisphenols employed.

The polycarbonates which are suitable according to the invention can be branched in a known manner, and in particular preferably by incorporation of branching agents which are trifunctional or more than trifunctional. Suitable branching agents are e.g. those with three or more than three phenolic groups or those with three or more than three carboxylic acid groups.

Suitable branching agents are, for example, phloroglucinol, 4,6-dimethyl-2,4,6-tri-(4-hydroxyphenyl)-hept-2-ene, 4,6-dimethyl-2,4,6-tri-(4-hydroxyphenyl)-heptane, 1,3,5-tri-(4-hydroxyphenyl)-benzene, 1,1,1-tris-(4-hydroxyphenyl)-ethane, tri-(4-hydroxyphenyl )-phenylmethane, 2,2-bis-[4,4-bis-(4-hydroxyphenyl)-cyclohexyl]-propane, 2,4-bis-(4-hydroxyphenyl-isopropyl)-phenol, 2,6-bis-(2-hydroxy-5′-methyl-benzyl)-4-methylphenol, 2-(4-hydroxyphenyl)-2-(2,4-dihydroxyphenyl)-propane, hexa-(4-(4-hydroxyphenyl-isopropyl)-phenyl)-terephthalic acid ester, tetra-(4-hydroxyphenyl)-methane, tetra-(4-(4-hydroxyphenyl-isopropyl)-phenoxy)-methane and 1,4-bis-(4′,4″-dihydroxytriphenyl)-methylbenzene and 2,4-dihydroxybenzoic acid, trimesic acid, cyanuric chloride, 3,3-bis-(3-methyl-4-hydroxyphenyl)-2-oxo-2,3-dihydroindole, trimesic acid trichloride and α,α′,α″-tris-(4-hydroxyphenyl)-1,3,5-triisopropylbenzene.

Preferred branching agents are 1,1,1-tris-(4-hydroxyphenyl)-ethane and 3,3-bis-(3-methyl-4-hydroxyphenyl)-2-oxo-2,3-dihydroindole.

The amount of branching agents optionally to be employed is preferably 0.05 mol % to 2 mol %, based on the moles of bisphenols employed.

In the case of the preparation of the polycarbonate by the phase interface process, for example, the branching agents can be initially introduced into the aqueous alkaline phase with the bisphenols and the chain terminators, or can be dissolved in an organic solvent together with the carbonic acid derivatives. In the case of the transesterification process, the branching agents are preferably metered in together with the dihydroxyaromatics or bisphenols.

Catalysts which are preferably to be employed in the preparation of polycarbonate by the melt transesterification process are the ammonium salts and phosphonium salts known from the literature (see, for example, U.S. Pat. No. 3,442,864, JP-A-14742/72, U.S. Pat. No. 5,399,659 and DE-A 19 539 290). Copolycarbonates can also be used. Copolycarbonates in the context of the invention are, in particular, polydiorganosiloxane/polycarbonate block copolymers, the weight-average molar weight (\overline{M}_{w}) of which is preferably 10,000 to 200,000 g/mol, particularly preferably 20,000 to 80,000 g/mol (determined by gel chromatography after prior calibration by light scattering measurement or ultracentrifugation). The content of aromatic carbonate structural units in the polydiorganosiloxane/polycarbonate block copolymers is preferably 75 to 97.5 wt. %, particularly preferably 85 to 97 wt. %. The content of polydiorganosiloxane structural units in the polydiorganosiloxane/polycarbonate block copolymer is preferably 25 to 2.5 wt. %, particularly preferably 15 to 3 wt. %. The polydiorganosiloxane/polycarbonate block copolymers can be prepared, for example, starting from polydiorganosiloxanes which contain α,ω-bishydroxyaryloxy end groups and have an average degree of polymerization of preferably Pₙ=5 to 100, particularly preferably Pₙ=20 to 80.

The polydiorganosiloxane/polycarbonate block polymers can also be a mixture of polydiorganosiloxane/polycarbonate block copolymers with conventional polysiloxane-free thermoplastic polycarbonates, the total content of polydiorganosiloxane structural units in this mixture preferably being 2.5 to 25 wt. %.

Such polydiorganosiloxane/polycarbonate block copolymers are characterized in that they contain in the polymer chain on the one hand aromatic carbonate structural units (1) and on the other hand polydiorganosiloxanes (2) containing aryloxy end groups

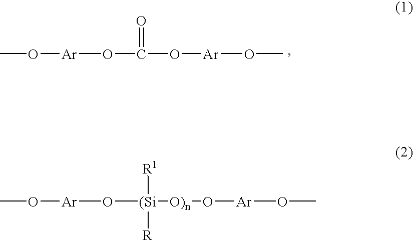

wherein

Ar are identical or different difunctional aromatic radicals and

R and R¹ are identical or different and denote linear alkyl, branched alkyl, alkenyl, halogenated linear alkyl, halogenated branched alkyl, aryl or halogenated aryl, preferably methyl, and

n denotes the average degree of polymerization of preferably 5 to 100, particularly preferably 20 to 80.

Alkyl in the above formula (2) is preferably C₁-C₂₀-alkyl, alkenyl in the above formula (2) is preferably C₂-C₆-alkenyl; aryl in the above formula (2) is preferably C₆-C₁₄-aryl. Halogenated in the above formula means partly or completely chlorinated, brominated or fluorinated.

Examples of alkyls, alkenyls, aryls, halogenated alkyls and halogenated aryls are methyl, ethyl, propyl, n-butyl, tert-butyl, vinyl, phenyl, naphthyl, chloromethyl, perfluorobutyl, perfluorooctyl and chlorophenyl.

Such polydiorganosiloxane/polycarbonate block copolymers and their preparation are described, for example, in U.S. Pat. No. 3,189,662, U.S. Pat. No. 3,821,325 and U.S. Pat. No. 3,832,419.

Preferred polydiorganosiloxane/polycarbonate block copolymers can be prepared e.g. by reacting polydiorganosiloxanes containing α,ω-bishydroxyaryloxy end groups together with other bisphenols, optionally with the co-use of branching agents in the conventional amounts, e.g. by the two phase interface process (as described, for example, in H. Schnell, “Chemistry and Physics of Polycarbonates”, Polymer Reviews, volume 9, p. 31-76, Interscience Publishers, New York, London, Sidney, 1964). The polydiorganosiloxanes containing α,ω-bishydroxyaryloxy end groups which are used as educts for this synthesis and their preparation are described, for example, in U.S. Pat. No. 3,419,634.

Conventional additives, such as e.g. mold release agents, stabilizers and/or flow agents, can be admixed to the polycarbonates in the melt or applied to the surface. The polycarbonates used preferably already comprise mold release agents before compounding with the other components of the molding compositions according to the invention.

Combinations of various thermoplastics can also expressly be employed according to the invention as component A, such as, for example, preferably PC/polyalkylene terephthalate, PC/PBT, PC/PET, PBT/PA, PET/PA, PBT/PS, PET/PS and PA/PS. PC/polyalkylene terephthalate mixtures, such as PC/PBT and PC/PET, are particularly preferred. Mixtures of PC/polyalkylene terephthalate, such as PC/PBT and PC/PET, in which the weight ratio of PC:polyalkylene terephthalate is in the range of 3:1 to 1:3, preferably in the range of 1:1 to 1:2.5, are most preferred.

As component B) the compounds comprise, according to the invention, one or a mixture of two or more different rubber-elastic polymers with a glass transition temperature below −5° C., preferably below −15° C., more preferably below −30° C., most preferably below −50° C., which are often also called impact modifiers, elastomers or rubbers.

Component B) according to the invention generally comprises copolymers, preferably graft copolymers of at least two, preferably three of the following monomers: styrene, acrylonitrile, butadiene, acrylic or methacrylic acid esters of alcohols having 1 to 18 C atoms as the alcohol component, vinyl acetate, ethylene, propylene, 1,3-butadiene, isobutene, isoprene and/or chloroprene. Such polymers of component B) are described e.g. in “Methoden der Organischen Chemie” (Houben-Weyl), vol. 14/1, Georg Thieme-Verlag, Stuttgart 1961, p. 392-406 and in C. B. Bucknall, “Toughened Plastics”, Appl. Science Publishers, London 1977. In the graft copolymers, at least one outer shell is grafted on to a core.

Graft copolymers which are preferably employed as component B) are obtained, for example, by a grafting reaction of styrene, acrylonitrile and/or methyl methacrylate on to a graft base of 1,3-butadiene, isoprene, n-butyl acrylate, styrene and/or 2-ethylhexyl acrylate, more preferably by a grafting reaction of acrylonitrile, styrene and/or methyl methacrylate on to a graft base of 1,3-butadiene, isoprene, n-butyl acrylate, styrene and/or 2-ethylhexyl acrylate.

Graft copolymers which are particularly preferred according to the invention are those in which methyl methacrylate or a mixture of methyl methacrylate and styrene is grafted on to a graft base based on 1,3-butadiene or on to a graft base of a mixture of 1,3-butadiene and styrene, which are also called MBS (methyl methacrylate/butadiene/styrene) rubbers. Graft copolymers in which acrylonitrile or a mixture of acrylonitrile and styrene is grafted on to a graft base based on 1,3-butadiene or on to a graft base of a mixture of 1,3-butadiene and styrene, which are also called ABS (acrylonitrile/butadiene/styrene) rubbers, are also particularly preferred according to the invention.

Graft copolymers in which n-butyl acrylate, n-butyl methacrylate, ethyl acrylate, methyl acrylate, 1,3-butadiene, isoprene and/or 2-ethylhexyl acrylate are grafted on to a graft base of 1,3-butadiene, isoprene, n-butyl acrylate, styrene and/or 2-ethylhexyl acrylate are also preferably employed as component B).

The monomer mixtures which are grafted on to the graft base can also expressly comprise monomers with an ethylenic double bond which are functionalized with additional reactive groups, such as, for example, epoxide or glycidyl, carboxyl, carboxylic acid anhydride, amino and/or amide groups, such as, for example, acrylamide, methacrylamide, (N,N-dimethylamino)ethyl acrylate, preferably maleic acid, fumaric acid, maleic anhydride, allyl glycidyl ether, vinyl glycidyl ether, glycidyl acrylate and glycidyl methacrylate.

According to the invention, crosslinking monomers can also be polymerized into the graft base and/or into outer shells, such as, for example, divinylbenzene, diallyl phthalate, dihydrodicyclopentadiene acrylate and/or 1,3-butadiene.

So-called graft-linking monomers which have at least two polymerizable double bonds, the double bonds polymerizing at different rates during the polymerization, can furthermore also be employed. Preferably, one double bond polymerizes at about the rate of the other monomers, while the other double bond or bonds do so significantly more slowly, so that a certain content of double bonds results from these in the rubber. When a further phase is grafted on, some of these double bonds can react with the graft monomers and thus partly bond the grafted-on phase chemically to the graft base. Examples which may be mentioned here are ethylenically unsaturated carboxylic acid esters, such as allyl acrylate, allyl methacrylate, diallyl maleate, diallyl fumarate or compounds mentioned in U.S. Pat. No. 4,148,846.

Component B) moreover preferably comprises one or a mixture of two or more different graft polymers with a graft base based on acrylates with a glass transition temperature of below −5° C. (such graft polymers are in general called acrylate rubbers and are known to the skilled artisan) or one or a mixture of two or more different elastic block polymers, in particular two- or three-block copolymers based on vinylaromatics and dienes, or mixtures of graft polymers and elastic block polymers.

The acrylate rubbers just mentioned which can also preferably be employed as component B) preferably comprise graft copolymers with rubber-elastic properties which are substantially obtainable from at least 2 of the following monomers: (meth)acrylic acid esters having 1 to 18 C atoms in the alcohol component, chloroprene, buta-1,3-diene, isoprene, styrene, acrylonitrile, ethylene, propylene and vinyl acetate, wherein the graft base contains at least one (meth)acrylic acid ester, that is to say polymers such as are also described e.g. in “Methoden der Organischen Chemie” (Houben-Weyl), vol. 14/1, Georg Thieme-Verlag, Stuttgart 1961, p. 393-406 and in C. B. Bucknall, “Toughened Plastics”, Appl. Science Publishers, London 1977.

Preferred polymers B) are partly crosslinked and have gel contents of more than 5 wt. %, preferably 20 wt. %, preferably above 40 wt. %, in particular above 60 wt. %.

Preferred acrylate rubbers as component B) are graft copolymer comprising

B.1) 95 to 5, preferably 10 to 80 wt. %, based on component B, of grafted-on component based on at least one polymerizable, ethylenically unsaturated monomer as the graft monomer and

B.2) 5 to 95, preferably 20 to 90 wt. %, based on component B, of acrylate rubber with a glass transition temperature of <−10° C., preferably <−20° C. as the graft base. B.2) can particularly preferably comprise polymers of acrylic acid esters or methacrylic acid esters which can contain up to 40 wt. %, based on B.2), of other ethylenically unsaturated monomers.

The acrylate rubbers according to B.2 are preferably polymers of acrylic acid alkyl esters or methacrylic acid alkyl esters, optionally with up to 40 wt. %, based on B.2, of other polymerizable, ethylenically unsaturated monomers. The preferred acrylic acid esters or methacrylic acid esters include C₁-C₈-alkyl esters, in particular methyl, ethyl, butyl, n-octyl and 2-ethylhexyl esters; and halogenoalkyl esters, preferably halogeno-C₁-C₈-alkyl esters, such as chloroethyl acrylate, and mixtures of these monomers.

Acrylic acid alkyl esters and methacrylic acid alkyl esters are preferably esters of acrylic acid or methacrylic acid with monohydric alcohols having 1 to 18 C atoms. Methacrylic acid methyl ester, ethyl ester and propyl ester, n-butyl acrylate, t-butyl acrylate and t-butyl methacrylate are particularly preferred.

Graft monomers of the grafted-on component B.1 are preferably chosen from at least one monomer, preferably 2 or 3 monomers, from the group consisting of styrene, α-methylstyrene, styrenes which are substituted on the nucleus by halogen or methyl, (meth)acrylic acid C₁-C₈-alkyl esters, acrylonitrile, methacrylonitrile, maleic anhydride, maleimides N-substituted by C₁-C₄-alkyl or phenyl or mixtures of these.

Particularly preferred graft copolymers B) comprise graft polymers of:

B.1) 5 to 95, preferably 10 to 80, in particular 30 to 80 parts by wt. of a mixture of

B.1.1 50 to 99, preferably 65 to 90 wt. % of methyl methacrylate, styrene, α-methylstyrene, styrenes substituted on the nucleus by halogen or methyl or mixtures of these compounds and

B.1.2 1 to 50, preferably 35 to 10 wt. % of methyl methacrylate, acrylonitrile, methacrylonitrile, maleic anhydride, maleimides N-substituted by C₁-C₄-alkyl or phenyl or mixtures of these compounds on

B.2) 5 to 95, preferably 20 to 90, in particular 20 to 70 parts by wt. of polymer based on alkyl acrylate with a glass transition temperature below −10° C., preferably less than −20° C.,

the sum of the parts by weight of B.1) and B.2) being 100.

Graft copolymers B) which are particularly preferred are those which are obtainable by a grafting reaction of

α 10 to 70, preferably 15 to 50, in particular 20 to 40 wt. %, based on graft polymer B, of at least one (meth)acrylic acid ester or 10 to 70, preferably 15 to 50, in particular 20 to 40 wt. % of a mixture of 10 to 50, preferably 20 to 35 wt. %, based on the mixture, of acrylonitrile or (meth)acrylic acid ester and 50 to 90, preferably 65 to 80 wt. %, based on the mixture, of styrene as the grafted-on component B.1 on

β 30 to 90, preferably 50 to 85, in particular 60 to 80 wt. %, based on graft copolymer B), of a graft base B.2) which comprises 70 to 100 wt. % of at least one alkyl-acrylate having 1 to 8 C atoms in the alkyl radical, preferably n-butyl acrylate and/or methyl n-butylacrylate and/or 2-ethylhexyl acrylate, in particular n-butyl acrylate as the sole acrylate, 0 to 30, preferably 0 to 15 wt. % of a further copolymerizable monoethylenically unsaturated monomer, such as butadiene, isoprene, styrene, acrylonitrile, methyl methacrylate or vinyl methyl ether or mixtures thereof, 0 to 5 wt. % of a copolymerizable, polyfunctional, preferably bi- and trifunctional, monomer which effects crosslinking, the weight data related to the total weight of the graft base.

Preferred graft polymers B) based on acrylate rubbers are e.g. bases B.2) grafted with (meth)acrylic acid alkyl esters and/or styrene and/or acrylonitrile. Acrylate rubbers based on n-butyl acrylate are particularly preferred as the graft base B.2).

Particularly preferred graft polymers B) based on acrylate rubbers are, in particular, those which contain less than 5 wt. % of polystyrene units, preferably less than 1 wt. % of polystyrene units, based on the total weight of the graft, particularly preferably no polystyrene units.

Component B) can also be a mixture of various graft copolymers.

The gel content of the graft base β is in general at least 20 wt. %, preferably 40 wt. % (measured in toluene) and the degree of grafting G is in general 0.15 to 0.55.

The average particle diameter of the graft copolymer of component B) is preferably 0.01 to 2 μm, more preferably 0.05 to 1.0, particularly preferably 0.1 to 0.08, in particular 0.1 to 0.4 μm.

The average particle diameter is determined, for example, on electron microscopy photographs (TEM) of ultra-thin sections of the molding compositions according to the invention, treated with OSO₄ and RuO₄, by measurement of a representative amount (approx. 50) of particles.

The average particle size d₅₀, determined by means of ultracentrifugation (W. Scholtan, H. Lange, Kolloid, Z. und Z. Polymere 250 (1972), 782-796), is the diameter above and below which in each case 50 wt. % of the particles lie. The average particle size d₅₀ of the graft polymers B) is preferably 0.1 to 0.6 μm.

The gel content of the graft base B.2 is determined at 25° C. in dimethylformamide (M. Hoffmann, H. Krömer, R. Kuhn, Polymeranalytik I und II, Georg Thieme-Verlag, Stuttgart 1977).

The degree of grafting G describes the weight ratio of grafted-on graft monomer to graft base and is dimensionless.

For crosslinking preferably of the polymers B) based on acrylate rubbers, monomers with more than one polymerizable double bond can be copolymerized. Preferred examples of crosslinking monomers are esters of unsaturated monocarboxylic acids having 3 to 8 C atoms and unsaturated monohydric alcohols having 3 to 12 C atoms or saturated polyols having 2 to 4 OH groups and 2 to 20 C atoms, such as e.g. ethylene glycol dimethacrylate and allyl methacrylate; polyunsaturated heterocyclic compounds, such as e.g. trivinyl and triallyl cyanurate; polyfunctional vinyl compounds, such as di- and trivinylbenzenes; and also triallyl phosphate and diallyl phthalate. Preferred crosslinking monomers are allyl methacrylate, ethylene glycol dimethacrylate, diallyl phthalate and heterocyclic compounds which contain at least 3 ethylenically unsaturated groups. Particularly preferred crosslinking monomers are the cyclic monomers triallyl cyanurate, triallyl isocyanurate, trivinyl cyanurate, triacryloylhexahydro-s-triazine, triallylbenzenes and the acrylic acid ester of tricyclodecenyl alcohol.

The amount of crosslinking monomers is preferably 0.02 to 5, in particular 0.05 to 2 wt. %, based on the graft base B.2.

In the case of cyclic crosslinking monomers with at least 3 ethylenically unsaturated groups it is advantageous to limit the amount to less than 1 wt. % of the graft base B.2.

The graft polymers B) can be prepared by known processes, such as bulk, suspension, emulsion or bulk-suspension processes.

Since as is known the graft monomers are not necessarily grafted completely on to the graft base during the grafting reaction, according to the invention graft polymers B) are also understood as meaning those products which are obtained by polymerization of the graft monomers in the presence of the graft base.

The graft polymers B) are preferably employed in a compacted form.

Component B) according to the invention furthermore comprises block polymers with rubber-elastic properties, in particular, for example, two-(A-B) and three-block copolymers (A-B-A). Block copolymers of the type A-B and A-B-A can show the typical behaviour of thermoplastic elastomers. The preferred block copolymers of the type A-B and A-B-A contain one or two vinylaromatic blocks (particularly preferably based on styrene) and one rubber block (particularly preferably a diene rubber block, most preferably a polybutadiene block or isoprene block), which in particular can optionally also be partly or completely hydrogenated.

Suitable block copolymers of type A-B and A-B-A are described e.g. in U.S. Pat. No. 3,078,254, 3,402,159, 3,297,793, 3,265,765 and 3,594,452 and in GB A 1 264 741. Examples of typical block copolymers of the type A-B and A-B-A are: polystyrene/polybutadiene (SBR), polystyrene/poly(ethylene-propylene), polystyrene/polyisoprene, poly(ε-methylstyrene)/polybutadiene, polystyrene/polybutadiene/polystyrene (SBR), polystyrene/poly(ethylene-propylene)/polystyrene, polystyrene/polyisoprene/polystyrene and poly(ε-methylstyrene)/polybutadiene/poly(ε-methylstyrene), and hydrogenated versions thereof, such as, for example and preferably, hydrogenated polystyrene/polybutadiene/polystyrene (SEBS) and hydrogenated polystyrene/polyisoprene (SEP). The use of corresponding hydrogenated block copolymers optionally in a mixture with the non-hydrogenated precursors as impact modifiers is described, for example, in DE-A 2 750 515, DE-A 2 434 848, DE-A 038 551, EP-A 0 080 666 and WO-A 83/01254. Reference is expressly made herewith to the disclosure of the publications mentioned.

Mixtures of the block polymers mentioned can also be employed.

Partly or completely hydrogenated block copolymers are particularly preferred, and hydrogenated polystyrene/polybutadiene/polystyrene (SEBS) and hydrogenated polystyrene/polyisoprene (SEP) are especially preferred.

Such block polymers of the type A-B and A-B-A are commercially obtainable from a number of sources, such as e.g. from Phillips Petroleum under the trade name SOLPRENE, from Shell Chemical Co. under the trade name KRATON, from Dexco under the trade name VECTOR and from Kuraray under the trade name SEPTON.

Component B furthermore also comprises one or more rubber-modified graft polymers. The rubber-modified graft polymer B comprises a random (co)polymer of vinyl monomers B.1, preferably according to B.1.1 and B.1.2, and a rubber B.2 grafted with vinyl monomers, preferably according to B.1.1 and B.1.2. The preparation of B is carried out in a known manner by free-radical polymerization, e.g. by an emulsion, bulk or solution or bulk-suspension polymerization process, as described e.g. in U.S. Pat. No. 3,243,481, U.S. Pat. No. 3,509,237, U.S. Pat. No. 3,660,535, U.S. Pat. No. 4,221,833 and U.S. Pat. No. 4,239,863. Particularly suitable graft rubbers are also ABS polymers, which are obtainable by redox initiation with an initiator system of organic hydroperoxide and ascorbic acid in accordance with U.S. Pat. No. 4,937,285.

One or more graft polymers of 5 to 95, preferably 20 to 90 wt. % of at least one vinyl monomer B.1 on 95 to 5, preferably 80 to 10 wt. % of one or more graft bases B.2 with glass transition temperatures of <10° C., preferably <−10° C., are preferred.

Preferred monomers B.1.1 are styrene, α-methylstyrene, styrenes substituted on the nucleus by halogen or alkyl, such as p-methylstyrene and p-chlorostyrene, and (meth)acrylic acid C₁-C₈-alkyl esters, such as methyl methacrylate, n-butyl acrylate and tert-butyl acrylate. Preferred monomers B.1.2 are unsaturated nitriles, such as acrylonitrile and methacrylonitrile, (meth)acrylic acid C₁-C₈-alkyl esters, such as methyl methacrylate, n-butyl acrylate and tert-butyl acrylate, derivatives (such as anhydrides and imides) of unsaturated carboxylic acids, such as maleic anhydride and N-phenyl-maleimide, or mixtures thereof.

Particularly preferred monomers B.1.1 are styrene, α-methylstyrene and/or methyl methacrylate, and particularly preferred monomers B.1.2 are acrylonitrile, maleic anhydride and/or methyl methacrylate.

Particularly preferred monomers are B.1.1 styrene and B.1.2 acrylonitrile.

Rubbers B.2 which are suitable for the rubber-modified graft polymers B are, for example, diene rubbers and acrylate, polyurethane, silicone, chloroprene and ethylene/vinyl acetate rubbers. Composites of various of the rubbers mentioned are also suitable as graft bases.

Preferred rubbers B.2 are diene rubbers (e.g. based on butadiene, isoprene etc.) or mixtures of diene rubbers or copolymers of diene rubbers or mixtures thereof with further copolymerizable vinyl monomers (e.g. according to B.1.1 and B.1.2), with the proviso that the glass transition temperature of component B.2 is below 10° C., preferably below −10° C. Pure polybutadiene rubber is particularly preferred. The rubber base can comprise up to 50 wt. %, preferably up to 30, in particular up to 20 wt. % (based on the rubber base B.2) of further copolymerizable monomers.

Suitable acrylate rubbers according to B.2 of the polymers B are, preferably, polymers of acrylic acid alkyl esters, optionally with up to 40 wt. %, based on B.2, of other polymerizable, ethylenically unsaturated monomers. The preferred polymerizable acrylic acid esters include C₁ to C₈-alkyl esters, for example the methyl, ethyl, butyl, n-octyl and 2-ethylhexyl ester; halogenoalkyl esters, preferably halogeno-C₁-C₈-alkyl esters, such as chloroethyl acrylate, and mixtures of these monomers. Preferred “other” polymerizable, ethylenically unsaturated monomers which can optionally be used for the preparation of the graft base B.2 in addition to the acrylic acid esters are e.g. acrylonitrile, styrene, α-methylstyrene, acrylamides, vinyl C₁-C₆-alkyl ethers, methyl methacrylate and butadiene. Preferred acrylate rubbers as the graft base B.2 are emulsion polymers which have a gel content of at least 60 wt. %.

Further suitable graft bases according to B.2 are silicone rubbers with grafting-active sites, such as are described in DE-A 3 704 657, DE-A 3 704 655, DE-A 3 631 540 and DE-A 3 631 539.

The gel content of the graft base B.2 is determined at 25° C. in a suitable solvent (M. Hoffmann, H. Krömer, R. Kuhn, Polymeranalytik I und II, Georg Thieme-Verlag, Stuttgart 1977).

The average particle size d₅₀ is the diameter above and below which in each case 50 wt. % of the particles lie. It can be determined by means of ultracentrifuge measurement (W. Scholtan, H. Lange, Kolloid, Z. und Z. Polymere 250 (1972), 782-1796).

If necessary and if the rubber properties of component B.2 are not thereby impaired, component B can additionally also comprise small amounts, conventionally less than 5 wt. %, preferably less than 2 wt. %, based on B.2, of ethylenically unsaturated monomers which have a crosslinking action. Examples of such monomers which have a crosslinking action are esters of unsaturated monocarboxylic acids having 3 to 8 C atoms and unsaturated monohydric alcohols having 3 to 12 C atoms or saturated polyols having 2 to 4 OH groups and 2 to 20 C atoms, polyunsaturated heterocyclic compounds, polyfunctional vinyl compounds, such as alkylene diol di(meth)acrylates, polyester di(meth)acrylates, divinylbenzene, trivinylbenzene, trivinyl cyanurate, triallyl cyanurate, allyl (meth)acrylate, diallyl maleate, diallyl fumarate, triallyl phosphate and diallyl phthalate.

Preferred crosslinking monomers are allyl methacrylate, ethylene glycol dimethacrylate, diallyl phthalate and heterocyclic compounds which contain at least three ethylenically unsaturated groups.

In the case of preparation by means of bulk or solution or bulk-suspension polymerization, the rubber-modified graft polymer B is obtained by grafting polymerization of 50 to 99, preferably 65 to 98, particularly preferably 75 to 97 parts by wt. of a mixture of 50 to 99, preferably 60 to 95 parts by wt. of monomers according to B.1.1 and 1 to 50, preferably 5 to 40 parts by wt.. of monomers according to B.1.2 in the presence of 1 to 50, preferably 2 to 35, particularly preferably 2 to 15, in particular 2 to 13 parts by wt. of the rubber component B.2.

The average particle diameter d₅₀ of the grafted rubber particles in general has values of 0.05to 10 μm, preferably 0.1 to 5 μm, particularly preferably 0.2 to 1 μm.

The average particle diameter d₅₀ of the resulting grafted rubber particles which are obtainable by means of bulk or solution or bulk-suspension polymerization processes (determined by counting on electron microscopy photographs) is in general in the range from 0.5 to 5 μm, preferably 0.8 to 2.5 μm.

Component B can comprise the graft copolymers by themselves or in any desired mixture with one another.

The polymer composition according to the invention preferably comprises component B in an amount of 0.5 to 50 parts by wt., particularly preferably 1 to 40 parts by wt., and very particularly preferably 1 to 35 parts by wt.

As component C) the compositions comprise, according to the invention, carbon nanofibrils.

Preferred carbon nanofibrils typically have the form of tubes formed from layers of graphite. The graphite layers are arranged around the cylindrical axis in a concentric manner.

Carbon nanofibrils have a length-to-diameter ratio of at least 5, preferably at least 100, particularly preferably at least 1,000. The diameter of the nanofibrils is typically in the range from 0.003 to 0.5 μm, preferably in the range from 0.005 to 0.08 μm, particularly preferably in the range from 0.006 to 0.05 μm. The length of the carbon nanofibrils is typically 0.5 to 1,000 μm, preferably 0.8 to 100 μm, particularly preferably 1 to 10 μm. The carbon nanofibrils have a hollow, cylindrical core around which the graphite layers are formally wound. This hollow space typically has a diameter of 0.001 to 0.1 μm, preferably a diameter of 0.008 to 0.015 μm. In a typical embodiment of the carbon nanofibrils, the wall of the fibrils around the hollow space consists, for example of 8 graphite layers. The carbon nanofibrils can be present here as aggregates of up to 1,000 μm diameter, preferably up to 500 μm diameter, of several nanofibrils. The aggregates can have the form of birds nests, of combed yarn or of open net structures.

The carbon nanofibrils can be added before, during or after the polymerization of the monomers to give the thermoplastic of component A). If the addition of the nanofibrils according to the invention takes place after the polymerization, it preferably takes place by addition to the thermoplastic melt in an extruder or in a kneader. By the compounding operation in the kneader or extruder, the aggregates already described can, in particular, be largely or even completely comminuted and the carbon nanofibrils can be dispersed in the thermoplastic matrix.

In a preferred embodiment, the carbon nanofibrils can be metered as highly concentrated masterbatches in thermoplastics, which are preferably chosen from the group consisting of the thermoplastics employed as component A). The concentration of the carbon nanofibrils in the masterbatches is in the range from 5 to 50, preferably 8 to 30, particularly preferably in the range from 12 to 22 wt. %. The preparation of masterbatches is described, for example, in U.S. Pat. No. 5,643,502. The comminution of aggregates can be improved in particular by the use of masterbatches. The carbon nanofibrils can have shorter length distributions in the molding composition or in the shaped article than originally employed as a result of the processing to the molding composition or shaped article.

Carbon nanofibrils are available, for example, from Hyperion Catalysis or Applied Sciences Inc. The synthesis of the carbon nanofibrils is carried out, for example, in a reactor which contains a carbon-containing gas and a metal catalyst, such as is described e.g. in U.S. Pat. No. 5,643,502.

As component D) the compositions comprise, according to the invention, particulate carbon compounds, such as carbon black, which is suitable for establishing conductivity and is also called conductivity carbon black by the skilled artisan, or graphite powder.

According to the invention, graphite powders are comminuted graphite. Graphite is understood by the skilled artinal as meaning a modification of carbon such as is described, for example, in A. F. Hollemann, E. Wieberg, N. Wieberg, “Lehrbuch der anorganischen Chemie”, 91st-1 00th ed., p. 701-702. Graphite consists of planar layers of carbon arranged one on top of the other.

Graphite can be comminuted according to the invention, for example, by grinding. The particle size is in the range from 0.01 μm to 1 mm, preferably in the range from 1 to 300 μm, most preferably in the range from 2 to 20 μm.

In conductivity carbon blacks according to the invention the primary particle size is between 0.005 and 0.2 μm, preferably between 0.01 and 0.1 μm. The dibutyl phthalate adsorption of the conductivity carbon blacks is between 40 and 1,000 ml per 100 g of carbon black, preferably between 90 and 600 ml per 100 g of carbon black. A large number of oxygen-containing groups, such as, for example, carboxyl, lactol and phenol groups, quinoid carbonyl groups and/or pyrone structures, can be present on the surface of the carbon black.

Conductivity carbon blacks can be prepared, for example, from acetylene, from synthesis gas or from the furnace process from oil, carrier gases and air. Preparation processes are described, for example, in R. G. Gilg, “Ruβ für leitfähige Kunststoffe” in: Elektrisch leitende Kunststoffe, ed.: H. J. Mair, S. Roth, 2nd ed., Carl Hanser Verlag, 1989, Munich, Vienna, p. 21-36.

The carbon blacks and/or graphites according to the invention can be added before, during or after the polymerization of the monomers to give the thermoplastic of component A). If the addition of the carbon blacks and/or graphites according to the invention takes place after the polymerization, it preferably takes place by addition to the thermoplastic melt in an extruder or in a kneader. According to the invention, the carbon blacks and/or graphites can also be metered as highly concentrated masterbatches in thermoplastics, which are preferably chosen from the group consisting of the thermoplastics employed as component A). The concentration of the carbon blacks and/or graphites in the masterbatches is in the range from 5 to 70, preferably 8 to 50, particularly preferably in the range from 12 to 30 wt. %. According to the invention, binders, such as, for example, waxes, fatty acid esters or polyolefins, can also be added to the carbon blacks and/or graphites for better meterability. According to the invention, the carbon blacks and/or graphites can also be pelleted or granulated, for example by pressing or pressure processes, with or without additional binders, this also being for better meterability.

In a preferred embodiment, mixtures of several graphites, mixtures of several carbon blacks or mixture of at least one graphite and at least one carbon black can also be employed as component D.

Conductivity carbon blacks according to the invention can be obtained, for example, under the name Ketjenblack from AKZO Nobel, under the name Vulcan from Cabot or under the name Printex from Degussa.

Graphites according to the invention can be obtained as powders, for example from Vogel & Prenner Nachf., Wiesbaden, Germany. As component E) the thermoplastic molding compositions comprise a filler or reinforcing substance or a mixture of two or more different fillers and/or reinforcing substances, for example based on talc, mica, silicate, quartz, titanium dioxide, wollastonite, kaolin, amorphous silicas, magnesium carbonate, chalk, feldspar, barium sulfate, glass beads and/or fibrous fillers and/or reinforcing substances based on carbon fibers and/or glass fibers. Mineral particulate fillers based on talc, mica, silicate, quartz, titanium dioxide, wollastonite, kaolin, amorphous silicas, magnesium carbonate, chalk, feldspar, barium sulfate and/or glass fibers are preferably employed. Mineral particulate fillers based on talc, wollastonite, kaolin and/or glass fibers are particularly preferred according to the invention.

Mineral fillers are preferably employed in particular for uses where isotropy with dimensional stability and a high thermal dimensional stability are required, such as, for example, in motor vehicle uses or vehicle body outer components, talc, wollastonite or kaolin being particularly preferred.

In the case where component B) is a block copolymer, the blends preferably comprise the mineral filler in an amount of 2.5 to 34, particularly preferably in an amount of 3.5 to 28, most preferably in an amount of 5 to 21 wt. %.

Needle-shaped mineral fillers are also particularly preferred. Needle-shaped mineral fillers are understood according to the invention as meaning a mineral filler with a highly pronounced needle-shaped character. Needle-shaped wollastonites may be mentioned as an example. The mineral preferably has a length:diameter ratio of 2:1 to 35:1, particularly preferably 3:1 to 19:1, most preferably 4:1 to 12:1. The average particle size of the needle-shaped materials according to the invention is preferably less than 20 μm, particularly preferably less than 15 μm, especially preferably less than 10 μm, most preferably less than 5 μm, determined with a CILAS GRANULOMETER.

Mineral fillers based on talc are also particularly preferred as component E). Possible mineral fillers based on talc in the context of the invention are all particulate fillers which the skilled artisan typically associates with talc or talcum. All particulate fillers which are commercially available and of which the product descriptions contain the terms talc or talcum as characterizing features are also possible.

Mineral fillers which have a content of talc according to DIN 55920 of greater than 50 wt. %, preferably greater than 80 wt. %, particularly preferably greater than 95 wt. %, and especially preferably greater than 98 wt. %, based on the total weight of filler, are preferred.

The mineral fillers based on talc can also be surface-treated. They can be treated, for example, with an adhesion promoter system, e.g. based on silane.

The mineral fillers according to the invention based on talc preferably have an upper particle or grain size d₉₇ of less than 50 μm, preferably less than 10, particularly preferably less than 6, and especially preferably less than 2.5 μm. As the average grain size d₅₀, a value of less than 10, preferably less than 6, particularly preferably less than 2, and especially preferably less than 1 μm is preferably chosen. The d₉₇ and d₅₀ values of the fillers E are determined by sedimentation analysis with a SEDIGRAPH D 5 000 or by sieve analysis in accordance with DIN 66 165.

The average aspect ratio (diameter to thickness) of the particulate fillers based on talc is preferably in the range of 1 to 100, particularly preferably 2 to 25, and especially preferably 5 to 25, determined on electron microscopy photographs of ultra-thin sections of the finished products and measurement of a representative amount (approx. 50) of filler particles.

The filler and/or reinforcing substance can optionally be surface-modified, for example with an adhesion promoter or adhesion promoter system, e.g. based on silane. However, the pretreatment is not absolutely necessary. If glass fibers in particular are used, polymer dispersions, film-forming agents, branching agents and/or glass fiber processing auxiliaries can also be used in addition to silanes.

Glass fibers, which in general have a fiber diameter of between 7 and 18, preferably between 9 and 15 μm, and can be added as continuous fibers or as cut or ground glass fibers, are also particularly preferred according to the invention, it being possible for the fibers to be treated with a suitable size system and an adhesion promoter or adhesion promoter system, e.g. based on silane.

The usual silane compounds for the pretreatment have, for example, the general formula

(X—(CH₂)_{q})ₖ—Si—(O—CᵣH₂ᵣ₊₁)₄₋ₖ

in which the substituents have the following meaning:

X NH₂—, HO—,

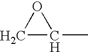

q an integer from 2 to 10, preferably 3 to 4

r an integer from 1 to 5, preferably 1 to 2

k an integer from 1 to 3, preferably 1

Preferred silane compounds are aminopropyltrimethoxysilane, aminobutyltrimethoxysilane, aminopropyltriethoxysilane, aminobutyltriethoxysilane and the corresponding silanes which contain a glycidyl group as the substituent X.

The silane compounds are in general employed for the surface coating in amounts of 0.05 to . . . , preferably 0.5 to 1.5, and in particular 0.8 to 1 wt. %, based on the mineral filler.

The particulate fillers can have a lower d₉₇ or d₅₀ value in the molding composition or in the shaped article than the fillers originally employed due to the processing to the molding composition or shaped article. The glass fibers can have shorter length distributions in the molding composition or in the shaped article than originally employed due to the processing to the molding composition or shaped article.

The particle diameter in the finished product can be determined here, for example, by recording electron microscopy photographs of thin sections of the polymer mixture and using at least 25, preferably at least 50 filler particles for the evaluation.

As component F) the compositions according to the invention can moreover comprise compatibilizing agents. Compatibilizing agents which are preferably employed are thermoplastic polymers with polar groups. Polymers which prepared from,

F.1 a vinylaromatic monomer,

F.2 at least one monomer chosen from the group consisting of C₂ to C₁₂-alkyl methacrylates, C₂- to C₁₂-alkyl acrylates, methacrylonitriles and acrylonitriles and

F.3 α,β-unsaturated components containing dicarboxylic acid anhydrides

may be employed according to the invention.

Styrene is particularly preferred as the vinylaromatic monomer F.1.

Acrylonitrile is particularly preferred for component F.2.

Maleic anhydride is particularly preferred for the α,β-unsaturated components F.3 containing dicarboxylic acid anhydrides.

Terpolymers of the monomers mentioned are preferably employed as component F.1, F.2 and F.3. Terpolymers of styrene, acrylonitrile and maleic anhydride are accordingly preferably employed. These terpolymers contribute in particular towards improving the mechanical properties, such as tensile strength and elongation at break. The amount of maleic anhydride in the terpolymer can vary within wide limits. The amount is preferably 0.2 to 5 mol %. Amounts of between 0.5 and 1.5 mol % are particularly preferred. Particularly good mechanical properties in respect of tensile strength and elongation at break are achieved in this range.

The terpolymer can be prepared in a manner known per se.

A suitable method is dissolving of the monomer components of the terpolymer, e.g. styrene, maleic anhydride or acrylonitrile, in a suitable solvent, e.g. methyl ethyl ketone (MEK). One or optionally more chemical initiators are added to this solution. Suitable initiators are e.g. peroxides. The mixture is then polymerized for several hours at elevated temperatures.

The solvent and the unreacted monomers are then removed in a manner known per se. The ratio between component F.1 (vinylaromatic monomer) and component F.2, e.g. the acrylonitrile monomer, in the terpolymer is preferably between 80:20 and 50:50. To improve the miscibility of the terpolymer with the graft copolymer of component B), an amount of vinylaromatic monomer F.1 which corresponds to the amount of vinyl monomer B.1 in the graft copolymer B is preferably chosen.

Examples of compatibilizing agents F which can be employed according to the invention are described in EP-A 785 234 and EP-A 202 214. The polymers mentioned in EP-A 785 234 in particular are preferred according to the invention.

Component F can comprise the compatibilizing agents by themselves or in any desired mixture with one another.

A further substance which is particularly preferred as the compatibilizing agent is a terpolymer of styrene and acrylonitrile in a weight ratio of 2.1:1 containing 1 mol % of maleic anhydride.

The amount of component F) in the polymer compositions according to the invention is preferably between 0.5 and 30 parts by wt., in particular between 1 and 20 parts by wt., and particularly preferably between 2 and 10 parts by wt. Amounts of between 3 and 7 parts by wt. are very preferred.

The compositions according to the invention can moreover comprise one or more thermoplastic vinyl (co)polymers as component G).

Suitable vinyl (co)polymers for component G) are polymers of at least one monomer from the group consisting of vinylaromatics, vinyl cyanides (unsaturated nitriles), (meth)acrylic acid (C₁-C₈)-alkyl esters, unsaturated carboxylic acids and derivatives (such as anhydrides and imides) of unsaturated carboxylic acids. (Co)polymers of

G.1 50 to 99, preferably 60 to 80 parts by wt. of vinylaromatics and/or vinylaromatics substituted on the nucleus (such as styrene, α-methylstyrene, p-methylstyrene or p-chlorostyrene) and/or methacrylic acid (C₁-C₈)-alkyl esters (such as methyl methacrylate, ethyl methacrylate or butyl methacrylate), and

G.2 1 to 50, preferably 20 to 40 parts by wt. of vinyl cyanides (unsaturated nitriles), such as acrylonitrile and methacrylonitrile, and/or (meth)acrylic acid (C₁-C₈)-alkyl esters (such as methyl methacrylate, n-butyl acrylate or tert-butyl acrylate) and/or imides of unsaturated carboxylic acids (e.g. N-phenylmaleimide)

are particularly suitable.

The (co)polymers G) are resinous, thermoplastic and rubber-free. The copolymer of G.1 styrene and G.2 acrylonitrile is particularly preferred. The (co)polymers G are known and can be prepared by free-radical polymerization, in particular by emulsion, suspension, solution or bulk polymerization. The (co)polymers preferably have average molecular weights Mw (weight-average, determined by light scattering or sedimentation) of between 15,000 and 200,000. Component G can comprise the vinyl (co)polymers by themselves or in any desired mixture with one another.

The polymer composition preferably comprises component G in an amount of 0 to 30 parts by wt., in particular 0 to 25 parts by wt., and particularly preferably 0 to 20 parts by wt., especially 0.5 to 10 parts by wt.

In addition to components A), B), C), D), E), F) and G), the compositions according to the invention can moreover comprise additives, such as e.g. flameproofing agents, fireproofing agents, such as e.g. phosphorus compounds, organic halogen compounds, nitrogen compounds and/or magnesium hydroxide, stabilizers, pigments, processing auxiliaries, such as e.g. lubricants, nucleating agents and rubber-elastic polymers (often also called impact modifier, elastomer or rubber), such as e.g. rubbers or polyolefins and the like.

Commercially available organic compounds or halogen compounds with synergists or commercially available organic nitrogen compounds or organic/inorganic phosphorus compounds or red phosphorus are suitable as flameproofing agents. Flameproofing additives, such as magnesium hydroxide or Ca—Mg carbonate hydrates (e.g. DE-A 4 236 122) can also be employed. Examples which may be mentioned of halogen-containing, in particular brominated and chlorinated, compounds are: ethylene-1,2-bistetrabromophthalimide, epoxidized tetrabromobisphenol A resin, tetrabromobisphenol A oligocarbonate, tetrachlorobisphenol A oligocarbonate, pentabromopolyacrylate and brominated polystyrene. Suitable organic phosphorus compounds are the phosphorus compounds according to WO-A 98/17720, e.g. triphenyl phosphate (TPP), resorcinol-bis-(diphenyl phosphate), including oligomers (RDP), and bisphenol A-bis-diphenyl phosphate, including oligomers (BDP), melamine phosphate, melamine pyrophosphate, melamine polyphosphate and mixtures thereof. Possible nitrogen compounds are, in particular, melamine and melamine cyanurate. Suitable synergists are e.g. antimony compounds, in particular antimony trioxide and antimony pentoxide, zinc compounds, tin compounds, such as e.g. tin stannate, and borates. Carbon-forming agents and tetrafluoroethylene polymers can be added.

Magnesium hydroxide moreover has proved itself for a long time as a flameproofing agent for polyamide.

The molding compositions according to the invention can comprise conventional additives, such as agents against thermal decomposition, agents against thermal crosslinking, agents against damage by ultraviolet light, plasticizers, lubricants and mold release agents, nucleating agents, antistatics and optionally further stabilizers.

The molding compositions according to the invention are prepared by mixing the particular constituents in a known manner and subjecting the mixture to melt compounding or melt extrusion at temperatures of between 200° C. to 380° C., usually between 250° C. and 350° C., in conventional units, such as e.g. internal kneaders, extruders and twin-screw extruders. Further additional substances, such as e.g. reinforcing substances, stabilizers, lubricants and mold release agents, nucleating agents and other additives, can be added during the melt compounding or melt extrusion step.

Examples of oxidation retardants and heat stabilizers which are mentioned are sterically hindered phenols and/or phosphites, hydroquinones, aromatic secondary amines, such as diphenylamines, various substituted representatives of these groups and mixtures thereof, in concentrations of up to 1 wt. %, based on the weight of the thermoplastic molding compositions.

As UV stabilizers, which are in general used in amounts of up to 2 wt. %, based on the molding composition, there may be mentioned various substituted resorcinols, salicylates, benzotriazoles and benzophenones.

Inorganic pigments, such as titanium dioxide, ultramarine blue, iron oxide and carbon black, and furthermore organic pigments, such as phthalocyanines, quinacridones and perylenes, and dyestuffs, such as nigrosine and anthraquinones, can be added as colouring agents as well as other colouring agents, those colouring agents which do not too greatly impair the mechanical properties of the molding composition preferably being employed.

Sodium phenylphosphinate, aluminium oxide, silicon dioxide and, preferably, talc can be employed e.g. as nucleating agents.

Lubricants and mold release agents, which are conventionally employed in amounts of up to 1 wt. %, are preferably ester waxes, pentaerythrityl stearate (PETS), long-chain fatty acids (e.g. stearic acid or behenic acid), their salts (e.g. Ca or Zn stearate) and amide derivatives (e.g. ethylene-bis-stearylamide) or montan waxes and low molecular weight polyethylene waxes or polypropylene waxes.

Examples of plasticizers which may be mentioned are phthalic acid dioctyl ester, phthalic acid dibenzyl ester, phthalic acid butyl benzyl ester, hydrocarbon oils and N-(n-butyl)benzenesulfonamide.

The addition use of rubber-elastic polymers (often also called impact modifier, elastomer or rubber) is particularly preferred.

The invention also provides a process for the preparation of the compositions, the use of the composition according to the invention for the production of shaped articles, molding compositions, semi-finished products and moldings, and shaped articles, molding compositions, semi-finished products and moldings produced therefrom.

The compositions according to the invention are prepared by processes which are known per se by mixing the components. It may be advantageous to premix individual components. Preferably, mixing of components A to E and further constituents is carried out at temperatures of 220 to 330° C. by common kneading, extrusion or milling of the components.

The molding compositions and shaped articles according to the invention have surface resistances in the range from 10¹⁵ to 10¹ preferably in the range from 10¹⁴ to 10³, particularly preferably in the range from 10¹² to 10⁴ ohm.

The compositions according to the invention can be processed to all types of semi-finished products or moldings by conventional processes.

Examples of processing processes which may be mentioned are extrusion processes and injection molding processes. Examples of semi-finished products which may be mentioned are films and sheets.

In an embodiment of the present invention, a method of preparing a molded article is provided. The method includes, (a) providing the thermoplastic composition of the present invention; and (b) extruding and/or injection molding the thermoplastic composition, thereby forming the molded article. The method of preparing the molded article may optionally further include applying a lacquer (coating or paint, which may be clear or pigmented) to the molded article by electrostatic means (e.g., electrostatic spray application, which is known to the skilled artisan). Lacquers (coatings) that may be used, include for example, clear coating compositions and pigmented coating compositions, that may be one-pack (e.g., blocked isocyanate compositions that are stoved) or two-component (e.g., polyol and polyisocyanate compositions that are curable at room temperature).

The moldings can be small or large and can be employed for external or internal uses. Large moldings are preferred for vehicle construction, in particular the automobile sector. In particular, vehicle body exterior components, such as e.g. mud guards, rear spoilers, engine bonnets, bumpers, loading areas, covers for loading areas, car roofs or other vehicle body built-on components, which are outstandingly suitable for electrostatic lacquering can be produced from the molding compositions according to the invention.

Small moldings are preferably produced for metering devices for aerosols, powders or granules, for chip carriers, for supports or packagings of electronic components for electrical, packaging or medical technology.

Compositions processed by extrusion, for example to films, are preferably employed in the packaging industry or for back-spraying.

The present invention also provides a composite molded article comprising at least two thermoplastic materials, wherein at least one of the thermoplastic materials comprises the thermoplastic composition of the present invention. The composite molded article may further comprise an electrostatically applied lacquer layer (e.g., as an exterior clear or pigmented coating layer).

### EXAMPLES

Component A1:

Linear polybutylene terephthalate (Pocan B 1300, commercial product of Bayer AG, Leverkusen, Germany) with an intrinsic viscosity of approx. 0.93 cm³/g (measured in phenol:1,2-dichlorobenzene=1:1 at 25° C.)

Component C1:

Carbon nanofibrils or carbon nanotubes from Hyperion Catalysis International, Cambridge, Mass. 02138, U.S.A. The carbon nanotubes were employed as a masterbatch with a wt. content of 15% carbon nanofibrils in PBT (Pocan B 1300, commercial product of Bayer AG, Leverkusen, Germany). The masterbatch was prepared by compounding on a twin-screw extruder. The actual content of carbon nanofibrils based on the total composition is stated in the example tables.

Component D1:

Conductivity carbon black of the type Vulcan XC 72 from Cabot, Suresnes-Cedex, France. The conductivity carbon black was employed as a masterbatch with a wt. content of 25% conductivity carbon black in PBT (Pocan P 1300, commercial product of Bayer AG, Leverkusen, Germany). The masterbatch was prepared by compounding on a twin-screw extruder. The actual content of conductivity carbon black based on the total composition is stated in the example tables.

Component E1:

Glass fibers sized with silane-containing compounds and having a diameter of 10 μm (CS 7967, commercial product of Bayer Antwerpen N.V., Antwerp, Belgium).

Conventional stabilizers, such as commercially available phosphite and/or phosphite ester stabilizers and/or phosphonate and/or phosphonate ester stabilizers, nucleating agents and mold release agents were used as additives.

Compoundings were carried out on a twin-screw extruder of the ZSK32 type (Werner und Pfleiderer) at melt temperatures of 260 to 312° C.

The test specimens were injection molded on an injection molding machine of the Arburg 320-210-500 type at melt temperatures of 250 to 280° C. and mold temperatures of 70 to 90° C.

The molding compositions according to the invention were tested according to the following methods:

Vicat B: Heat distortion stability or heat distortion temperature in accordance with DIN ISO 306/B 120 in silicone oil.

Izod impact strength: Toughness in accordance with ISO 180 method 1 U.

MVR: Flowability in accordance with DIN/ISO 1133 at 260° C. and 2.16 kg.

Flexural modulus, flexural strength and outer fiber strain at flexural strength: Determined in accordance with ISO 178

Surface resistance: In accordance with DIN IEC 60093 (12.93) on circular sheets of diameter 80 mm and thickness 2 mm.

The composition and properties of the thermoplastic molding compositions according to the invention can be seen from tables 1 to 2.

The examples from Table 1 show that for non-reinforced thermoplastics good conductivities can indeed be realized with carbon nanofibrils (comp. 2), but the flowability is unacceptably poor. With conductivity carbon blacks alone (comp. 3) acceptable flowabilities are indeed realized at the same carbon content, but the surface resistance is unacceptably high and approximately corresponds to that of thermoplastic to which no additives have been added (comp. 1). By combination of conductivity carbon black and carbon nanofibrils, however, acceptably low surface resistances and at the same time acceptably high flowabilities can be realized at the same total carbon content (ex. 1). At the same time, the impact strength in ex. 1 from a combination of conductivity carbon black and carbon nanofibrils is higher than in comp. 2, in which only carbon nanofibrils are employed. Example 1 was outstandingly suitable for electrostatic lacquering with a solvent-containing lacquer system.

The examples from Table 2 show that for reinforced thermoplastics good conductivities can indeed be realized with carbon nanofibrils (comp. 5), but the flowability is unacceptably poor. With conductivity carbon blacks alone (comp. 6) acceptable flowabilities are indeed realized at the same carbon content, but the surface resistance is unacceptably high and approximately corresponds to that of thermoplastic to which no additives have been added (comp. 4). By combination of conductivity carbon black and carbon nanofibrils, however, acceptably low surface resistances and at the same time acceptably high flowabilities can be realized at the same total carbon content (ex. 2). Example 2 was outstandingly suitable for electrostatic lacquering with a solvent-containing lacquer system.

TABLE 1

| | | | Comp. 2 | | |
|---|---|---|---|---|---|
| | | Comp. 1 | 656a | Ex. 1 | Comp. 3 |
| Component A1 | [%] | 99.6 | 95.2 | 95.2 | 95.2 |
| Component C1 | [%] | — | 4.4 | 2.4 | — |
| Component D1 | [%] | — | — | 2 | 4.4 |
| Additives | [%] | 0.4 | 0.4 | 0.4 | 0.4 |
| Total carbon content = | [%] | | 4.4 | 4.4 | 4.4 |
| comp. C1 + comp. D2 | | | | | |
| MVR (260° C./2.16 kg) | [cm³/10 min] | 68 | 7 | 26 | 27 |
| Vicat B 120 | [° C.] | 197 | 197 | 196 | 194 |
| Izod impact strength (23° C.) | [kJ/m²] | 120 | 26 | 38 | 37 |
| Surface resistance | [Ω] | 6 · 10¹⁶ | 4 · 10⁴ | 4 · 10⁷ | 2 · 10¹⁶ |

TABLE 2

| | | Comp. 4 | Comp. 5 | Ex. 2 | Comp. |
|---|---|---|---|---|---|
| | | 654j | 654d | 654e | 6 654f |
| Component A1 | [%] | 68.6 | 65.6 | 65.6 | 65.6 |
| Component C1 | [%] | — | 3 | 1.5 | |
| Component D1 | [%] | — | | 1.5 | 3 |
| Component E1 | [%] | 30 | 30 | 30 | 30 |
| Additives | [%] | 1.4 | 1.4 | 1.4 | 1.4 |
| Total carbon content = | [%] | 0 | 3.0 | 3.0 | 3.0 |
| comp. C1 + comp. D2 | | | | | |
| MVR (260° C./2.16 kg) | [cm³/10 min] | 16 | 1 | 6 | 14 |
| Vicat B 120 | [° C.] | 216 | 214 | 215 | 214 |
| Izod impact strength (23° C.) | [kJ/m²] | 53 | 46 | 42 | 41 |
| Surface resistance | [Ω] | 2 · 10¹⁶ | 9 · 10⁴ | 1 · 10¹³ | 1 · 10¹⁶ |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A thermoplastic composition comprising:
A) 99.6 to 10 parts by weight of at least one thermoplastic polymer;
B) 0 to 50 parts by weight of at least one rubber-elastic polymer;
C) 0.2 to 10.0 parts by weight of carbon nanofibrils;
D) 0.2 to 10.0 parts by weight of at least one particulate carbon compound; and
E) 0 to 50 parts by weight of at least one of filler and reinforcing substance.

2. The thermoplastic composition of claim 1 wherein said composition comprises:
A) 99.0 to 55 parts by weight of at least one thermoplastic polymer;
B) 5 to 25 parts by weight of at least one rubber-elastic polymer;
C) 1.5 to 2.5 parts by weight of carbon nanofibrils;
D) 1.5 to 4.0 parts by weight of at least one particulate carbon compound, said particulate carbon compound being an electrically conductive particulate carbon compound; and
E) 5 to 30 parts by weight of at least one of filler and reinforcing substance.

3. The composition of claim 1 wherein component (A) comprises a thermoplastic polyester.

4. The composition of claim 1 wherein component (A) comprises a mixture of polyalkylene terephthalate and polycarbonate.

5. The composition of claim 1 wherein component (A) comprises at least one polyamide.

6. The composition of claim 1 wherein component (B) is present.

7. The composition of claim 1 wherein the carbon nanofibrils (C) have a length-to-diameter ratio of at least 1,000.

8. The composition of claim 1 wherein component (D) is graphite having a particle size in the range from 0.1 μm to 1 mm.

9. The composition of claim 1 wherein component (D) is electrically conductive carbon black having a primary particle size of 0.005 μm to 0.2 μm.

10. The composition of claim 1 further comprising a compatilizing agent (F).

11. A method of preparing a molded article comprising:
(a) providing the thermoplastic composition of claim 1; and
(b) at least one of extruding and injection molding said thermoplastic composition, thereby forming said molded article.

12. The molded article prepared by the method of claim 11.

13. The method of claim 11 further comprising applying electrostatically a lacquer to said molded article.

14. A composite molded article comprising at least two thermoplastic materials, wherein at least one of said thermoplastic materials comprises the thermoplastic composition of claim 1.

15. The composite molded article of claim 14 further comprising an electrostatically applied lacquer layer.

16. The electrostatically lacquered molded article of claim 13.

17. Compositions and molded article according to one or more of the above claims having a surface resistance of 10¹³ to 10² Ohms.

18. Compositions and molded articles according to one or more of the above claims, having a surface resistance of 10¹⁰ to 10⁴ Ohms.

19. A composition according to claim 3 containing 0 to 5% of the filler or reinforcing substance E and having a melt volume rate (MVR) of at least 10 cm³/min, measured at 260° C./2.16 kg.

20. A composition according to claim 3 containing more than 5% of the filler or reinforcing substance E and having a melt volume rate (MVR) of at least 5 cm³/min, measured at 260° C./2.16 kg.
